(19) United States
(12) Patent Application Publication
(10) Pub. No.: US 2025/0349274 A1
(43) Pub. Date: Nov. 13, 2025

(54) Travel Ready Barrel Drum and Pandero

(71) Applicant: Jean Carlos González, Gautier, MS (US)

(72) Inventor: Jean Carlos González, Gautier, MS (US)

(21) Appl. No.: 18/662,331

(22) Filed: May 13, 2024

(51) Int. Cl. G10D 13/22; G10D 13/02; G10D 13/16; G10D 13/20

(52) U.S. Cl. CPC G10D 13/22; G10D 13/02; G10D 13/16; G10D 13/20

(57) ABSTRACT

The present invention is a percussive instrument containing a pandero body that attaches to a barrel drum body, with the barrel drum body acting as an air chamber, increasing the resonance of the sound that is made when the skins of the pandero body are struck. In one embodiment of the invention, the barrel drum body can be disassembled into a plurality of curved segments for easy storage and travel. The Barrel drum body can be reassembled by aligning the curved segments properly and attaching them to one another to form the barrel drum body. In another embodiment of the invention, the barrel drum body cannot be disassembled.

### BACKGROUND OF THE INVENTION

The present disclosure relates to barrel drums and panderos and, more particularly, to barrel drums and panderos that can be dismounted for easy travel.

Barrel drums and panderos are typically used in traditional Puertorican music such as Bomba and Plena. Many percussionists play both the Bomba Barrel Drum and the Pandero. These music genres are usually played in the same shows, parties, gatherings, etc, meaning that percussionists who play Bomba and Plena music are often required to play both instruments in the same show, party, gathering, etc. The barrels used to make Bomba Barrel Drums are built in the traditional way of preparing a rum or whisky barrel. Staves of wood are cut, humidified, bent and dried to create the necessary shape so that when these staves are glued together, the shape obtained is that of a barrel. However, a skin tightening mechanism is placed on it near the top of the barrel and a skin is stretched on it using said mechanism. This creates a membranophone instrument out of the barrel and the barrel itself becomes a sound or air chamber that amplifies and modifies the tone of the instrument.

The same process is done to build the pandero portion of the body of the instrument using smaller staves of wood than the ones used for the barrel. Many Bomba and Plena percussionists travel. This can prove to be particularly difficult for the barrel drum players because barrel drums are generally large and heavy. Adding to that the burden of also having to lug a pandero, makes this a very difficult task. The invention claimed in this application looks to solve that problem by providing the percussionist with an instrument that can change from a barrel drum to a pandero with a flip of a couple of latches. This invention also looks to solve the travel issue of a bomba barrel drum by segmenting it and, in doing so, being able to fit it inside a carry-on suitcase.

### SUMMARY

Embodiments of the present invention disclose a percussive instrument, comprising: a pandero body, comprising a plurality of hooks, a bottom groove, a removable top ring, a plurality of top ring ears, a removable bottom ring, a plurality of bottom ring ears, a plurality of tuning logs attached to the top ring ear and fed through the bottom ring ear and threaded at the bottom, a plurality of nuts and watchers that can be spun up and down and tightened on said tuning lugs, and a plurality of hooks attached to the bottom ring. A plurality of curved segments are arranged and attached to each other to form the barrel drum body. Each curved segment comprises a top groove, a bottom groove, a vertical latch located in an upper extremity of the curved segment, a first side comprising plugging holes and a second side comprising dowels. The plurality of curved segments forms a cylindrical barrel drum body by successively attaching the dowel side of one segment to the corresponding plugging side of another segment. A top metal strap and a bottom metal strap, each comprising a horizontal latch, are placed in the corresponding top groove and bottom groove and are latched and used to attach the plurality of curved segments and maintain the barrel drum body. The pandero body is then attached to the barrel drum body by attaching the vertical latch located at the upper extremity of each curved segment of the barrel drum body to the corresponding hooks on the bottom ring of the pandero body.

To transport the embodiment of the invention, simply un-attach the pandero body by unlatching the vertical latch on the upper extremity of each of the curved segments from the hooks on the bottom ring of the pandero body. Then, unlatch the horizontal latch of the top metal strap and bottom metal strap. Separate the plurality of curved segments by pulling the dowel side of each curved segment from the plugging side of each curved segment. Stack the plurality of curved segments on top of each other, stack the top metal strap and bottom metal strap on top of the plurality curved segments. And stack the pandero body on top of the top metal strap and bottom metal strap. In this embodiment of the invention claimed in the present application, the invention can be fit in a carry-on sized luggage and can be easily transported, compared to lugging a heavy barrel drum and a pandero drum.

### BRIEF DESCRIPTION OF THE DRAWINGS

FIG. 1 shows an exemplary embodiment of the invention, according to an exemplary embodiment of the present invention.

FIG. 2 shows an expanded view of the invention, according to an exemplary embodiment of the present invention.

FIG. 3 shows an exemplary embodiment of the Pandero body of the invention.

FIG. 4 shows multiple views at different angles of an exemplary embodiment of the invention disassembled, stacked and ready for storage.

FIG. 5 shows an exemplary embodiment of a stave of wood used for the barrel body or barrel body segment and a stave of wood used for the pandero body.

FIG. 6 shows multiple views of an exemplary embodiment of the invention where all the staves are glued together and without the stacking capabilities with the pandero body of the invention attached, as well as one view of an exemplary embodiment of the invention where all the staves are glued together and without the stacking capabilities with the pandero body of the invention detached.

### DETAILED DESCRIPTION

Though not limited to only this embodiment, an exemplary embodiment of the invention, according to this application is a percussive instrument, comprising: a pandero body, comprising a plurality of hooks, a bottom groove, a removable top ring, a plurality of top ring ears, a removable bottom ring, a plurality of bottom ring ears, a plurality of tuning lugs attached to the top ring ear and fed through the bottom ring ear and threaded at the bottom, a plurality of lug nuts and washers that can be spun up and down and tightened on said tuning lugs, and a plurality of hooks attached to the bottom ring; a top metal strap and a bottom metal strap, each comprising a horizontal latch; and a plurality of curved segments, each curved segment comprising a top groove, a bottom groove, a vertical latch located in an upper extremity of each of the curved segments, a first side comprising plugging holes and a second side comprising dowels; wherein the plurality of curved segments forms a cylindrical barrel drum body by successively attaching the dowel side of one segment to the corresponding plugging side of another segment; wherein each vertical latch of the plurality of curved segments attaches to a corresponding hook in the pandero body; and wherein the horizontal latch of the top metal strap attaches the top metal strap to the top groove and the horizontal latch of the bottom metal strap attaches the bottom metal strap to the bottom groove to hold the barrel drum body in place.

A barrel drum body is made using a minimum of ten staves of wood and a maximum of eighty staves of wood, all the staves being the same width, thickness and length, with a minimum width of each stave of one inch and a maximum width of five inches, a minimum thickness of each stave of one fourth inch and a maximum thickness of one inch, and a minimum length of fifteen inches and a maximum length of twenty six inches. Each stave is cut along both sides of its length at a minimum angle of seventy two degrees and a maximum of eighty eight degrees, said angle cut known commonly as a bevel, and arranging each stave to fit flush into each other at each cut edge such that it forms a cylindrical shape giving the barrel its corresponding width at the top, middle or bilge, and bottom.

The staves are held together temporarily at the top of the barrel using metal hoops leaving at least two and a half inches of wood between the top edge and the metal hoop, forming a cone shape. They are then inserted into a chamber and steamed for fifteen minutes per each quarter inch of thickness of the staves, softening the wood. After steaming it, the bottom is shaped by tying a rope or cable at the bottom end of the staves leaving at least two and a half inches of wood between the tying mechanism and the bottom edge, bending the wood and forming the barrel. After achieving the desired barrel shape, a temporary metal hoop is also placed at the bottom to maintain the staves in said desired barrel shape while said staves are left to cool down, dry and reduce the humidity the wood to about seven percent to nine percent humidity. Once achieving the desired seven percent to nine percent humidity, the temporary metal hoops are removed and the staves are separated from each other into a plurality of groups of any desired amount, henceforth called Segments. Ideally it would be four groups of the same amount of staves. Glue is then applied to all of the Bevels except the outer two of each group.

The staves of each group are then glued to one another leaving the two staves of each segment with the outer bevels without glue towards the outer edges of the group, said outer bevels without glue being the outer bevels of each segment, forming the segments with a semi-circle shape each so that when fitted together they form a cylindrical barrel and when separated, they can be laid down and stacked upon each other for easy transportation. The segments are fitted together to form the barrel shape and two temporary metal hoops are placed on the barrel, one at the top and one at the bottom, and tightened to maintain the barrel body shape as the glue on each of the segments sets.

Once the glue sets, the temporary metal hoops are removed. The four segments are sanded, A Top Groove one inch wide and 1/16 inches deep is cut at 2 to 4 inches from the top edge of the segments and a bottom groove one inch wide and 1/16 inches deep is cut at 2 to 4 inches, matching the top groove, from the bottom edge of the segments. Three dowel pins are attached at the left free bevel of each segment. One an inch from the top edge, one in the middle, and one an inch from the bottom edge. Three plugging holes matching the width of the dowel pins are then drilled on the right free bevel of each segment. One an inch from the top edge, one in the middle and one an inch from the bottom edge. A clear coat of lacquer, or any other clear coating material or wood finishes such as polyurethane, epoxy, polyacrylic, tungsten oil, etc, is applied to the barrel to seal and protect the wood.

Two 20-gauge metal straps with a width of one inch and the length of the circumference of the barrel body are used to make the metal straps that will hold the plurality of groups in place and maintain the barrel body shape. A Latch is attached to one end of each metal strap and a hook is attached to the other end of each metal strap. Once the protective clear coat is set, The Barrel Body is assembled inserting the Dowel Pins on each of the segments into the plugging holes drilled on the other segments until A Barrel Shape is formed, Then a metal strap is wrapped around the top grove and the hook at one end of the strap is inserted in the latch at the other end of the strap and the latch tightened shut. Then the other metal strap is wrapped around the bottom groove and the hook at one end of the metal strap is inserted in the latch at the other end of the metal strap and the latch is tightened shut. One metal latch is attached, using screws, to the top middle of each segment, at least ¼ of an inch to ½ of an inch from the top edge, each one matching the other segments, said latches attach to the metal hooks on the metal ring of the pandero.

A pandero is made of a minimum of 10 wooden staves and a maximum of 80 wooden staves, matching the number of staves used for the barrel, with a minimum width of each stave of 1 inch and a maximum of 5 inches, matching the width of the staves used for the barrel, a minimum thickness of each stave of a quarter inch and a maximum thickness of 1 inch, matching the thickness of staves used for the barrel, and a minimum length of the staves of 1.5 inches and a maximum length of 4 inches, each stave is then cut along both sides of the length at an angle of a minimum 72° and a maximum 88° matching the degrees used for the staves of the barrel, said angle is also commonly known as the bevel. Then, the staves are arranged in a circular pattern to form the pandero body like a frame drum, said staves are fitted flush at each others bevels to form said circular shape.

A temporary metal hoop is placed and tightened at the bottom of the staves giving the staves a cone shape and said metal hoop is used to maintain the shape of the staves while said staves dry to about seven percent to nine percent humidity. Once at the desired humidity range, said temporary metal hoop is removed, the staves are separated, glue is applied to the bevels face at each side of the length of the staves, said staves are once again assembled in the circular shape desired and fitted flush with each other. The temporary metal hoop is once again used to maintain the circular shape of the staves while the glue sets. Once the glue sets, the temporary metal hoop is removed and the resulting frame is sanded and the top outer edge is rounded. After sanding, a groove ⅝ inches in width and 3/16 inches in depth is then cut on the outer bottom part of the pandero body to be able to receive the bottom ring and a clear coat of lacquer, or any other clear coating material or wood finishes such as polyurethane, epoxy, polyacrylic, tungsten oil, etc, is applied to the pandero body to seal and protect the wood.

A removable top ring is made from a first flat metal bar with a width of ½ inch to ¾ inch, a thickness of ⅛ inch to ¼ inch, and the length varies depending on the circumference and diameter of the pandero body. Said first flat metal bar is bent to a ring and is welded to the desired circumference to fit the top of the pandero body to form the top ring. The tips from both ends of 4 to 8 metal rods 3/16 inches thick and 3 inches long are bent into right angles to form the top ring ears. In the middle of said top ring ears an indentation is made forming a wide “V” shape finishing the desired shape and aesthetic of the top ring ears. Holes are made into the top ring to receive said top ring ears. The top ring ears are fitted through the top ring holes from the outside of the top ring and are welded from the inside of the top ring. A removable bottom ring is made from a second flat metal bar with a width of ½ inch to ¾ inch, a thickness of ⅛ inch to ¼ inch, and the length varies depending on the circumference and diameter of the groove cut into the outer bottom part of the pandero body. Said second flat metal bar is bent into a ring shape and welded to the desired circumference to fit the groove cut into the bottom of the pandero body to form the bottom ring. 4 to 8 small flat metal bars, matching the amount of metal rods used for making the top ring ears, ½ inch wide, ⅛ inch thick, 2 inches long, are bent into a “U” shape, forming to bottom ring ears and are welded onto the bottom ring, matching the top ring ears to receive tuning lugs fitted through the top ring ears.

Metal rods 5/16 inches thick and 3 and ¼ inches long are shaved at 1 and ¼ inches at the top, shaving off from 5/16 to 3/16. Said shaved top is then bent to a “c” shape allowing the tuning log to hook on to the wide “v” of the top ring ear and allowing the bottom part of the rods to be fed through the bottom ring ear. The not shaved part of the rod is threaded so that a lug nut can be spun up and down and tightened on it. Nuts and watchers are then used to secure the tuning lugs and said nuts are tightened at the bottom of the tuning lugs to hold these in place and to tighten the skin to the desired tuning. Small flat metal bars ½ inch wide, ⅛ inch thick, 1 and ⅛ inches long, are bent into a “j” shape to act as a hook for the latches at the top of the barrel drum body to latch on to. These j shaped metal bars are welded onto the bottom ring not interfering with the bottom ring ears, with the bottom of the “j” level or flush to the bottom of the bottom ring.

A steel rod with a diameter from 3/16 to ¼ inches and a little bigger than the top ring, in terms of diameter, of the pandero body is welded in a ring shape to form the skin ring. The skin is wrapped on the skin ring. After the clear coat is set, the Bottom Ring is fitted in the groove on the bottom of the pandero body. The skin ring is then placed on top of the pandero body and the top ring is fitted on top of the skin ring. The “c” part of the tuning lugs is then hooked on to the wide “v” bend of the top ring ears and the bottom of the tuning lugs is fed through the bottom ring ears. Washers are put in the tuning lugs and nuts are then tightened on the bottom of the tuning lugs to secure them in place and to tighten the skin to the desired tuning. The “j” shaped metal bars are matched with the latches at the top of the barrel serum body, the bottom of the “j” is inserted in the latches and the latches are tightened shut forming a tight fit and keeping the pandero and the barrel drum body together giving a better resonance.

Compared to the invention, a common bomba barrel drum is difficult to travel with given the size, weight and shape of a barrel drum. A common bomba barrel drum cannot fit in the carry-on compartment of an airplane. Meaning a percussionist traveling with a bomba barrel drum must check it at the airline counter and risk it being damaged by airline workers who miss handle it. The invention can be divided into a plurality of segments and stored in a carry-on bag, which in turn can be placed in the overhead storage compartments in airplanes, allowing for safer and easier travel.

Compared to the invention, a common pandero cannot be used as a bomba barrel drum. The lack of the barrel drum body attributes to the lack of resonance, making it impossible to properly play bomba music on a pandero. A common barrel drum can be very heavy, traveling with it can prove to be difficult, and it cannot be used as a pandero to play plena music. The pandero body of the invention can be disattached from the barrel drum body to be used as a pandero to play plena music. The pandero body can also be attached or reattached to the barrel drum body to be used as a bomba barrel drum to play bomba music. This eliminates the hassle of needing two different instruments to play bomba and plena music.

Compared to the invention, a common frame drum can not be used as a bomba barrel drum. The lack of the barrel drum body attributes to the lack of resonance, making it impossible to properly play bomba music on it. The common frame drum also can not be used as a pandero because of the lack of tuning lugs, meaning that the common frame drum lacks the ability to tune the skins to the desired tuning. This makes it difficult to play plena music on the common frame drum as well. This also posses an economic challenge because in some cases with a common frame drum, the purchaser would need to buy new frames with skins, and on other occasions, new frame drums all together.

There is a Djembe drum set sold on the internet that can remove the drum heads in order to store them in a russian nesting doll fashion, as in, the smaller drum goes in the bigger drum. The removed drum head can be played as a frame drum. However, the skin cannot be tightened to tune them and cannot be replaced. If the skin breaks, you would have to buy a new frame with the skin to replace the frame drum with the broken skin. This is a major economic disadvantage given that you would have to buy an entire frame with the skin already attached instead of just buying a new skin and attaching it to the already owned frame. The assembly of the skin uses a rubber ring to create pressure between the frame drum and the inner drum body of the djembe to hold the frame drum in place. This is a disadvantage because the rubber ring can break or shift when applying the pressure to insert the frame drum into the djembe, causing a possible lack of grip and malfunction. Finally, the non cylindrical drum body shape of these djembe drums affects the sound. The cylindrical shape of the barrel drum body of the invention gives the sound better resonance. The fact that the skins can be changed and tuned without having to change the entire frame is also a big difference.

Detailed descriptions of one or more of the preferred embodiments are provided herein. It is to be understood, however, that the present disclosure may be embodied in various forms. Therefore, specific details disclosed herein are not to be interpreted as limiting, but rather as a basis for the claims and as a representative basis for teaching one skilled in the art to employ the present invention in any appropriate system, structure, or manner.

The preferred embodiment, though not limited to it, is a a percussive instrument comprising a pandero body, comprising a plurality of hooks, a bottom groove, a removable top ring, a plurality of top ring ears, a removable bottom ring, a plurality of bottom ring ears, a plurality of tuning lugs attached to the top ring ear and fed through the bottom ring ear and threaded at the bottom, a plurality of nuts and washers that can be spun up and down and tightened on said tuning lugs, and a plurality of hooks attached to the bottom ring, a top metal strap and a bottom metal strap, each comprising a horizontal latch, and a plurality of curved segments, each curved segment comprising a top groove, a bottom groove, a vertical latch located in an upper extremity of each curved segment, a first side comprising plugging holes and a second side comprising dowels, wherein the plurality of curved segments forms a cylindrical barrel drum body by successively attaching the dowel side of one segment to the corresponding plugging holes side of another segment, wherein each vertical latch of the plurality of curved segments attaches to a corresponding hook in the pandero body, and wherein the horizontal latch of the top metal strap attaches the top metal strap to the top groove and the horizontal latch of the bottom metal strap attaches the bottom metal strap to the bottom groove to hold the barrel drum body in place

In the present disclosure, the bodies of the instrument can be made from wood, carbon fiber, fiberglass, metal, plastic, or any other durable material which can be shaped and is hard enough to resist the stretching of skin over one the top opening of the pandero.

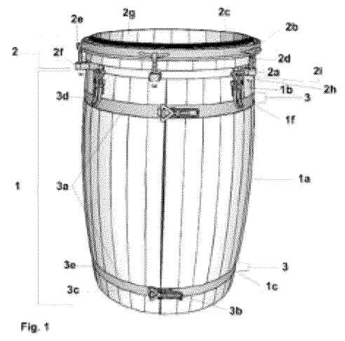

FIG. 1 shows an exemplary embodiment of the invention, according to this application. The instrument constructed in accordance with this application comprises two bodies, the barrel drum body 1 and the pandero body 2. The barrel drum body 1 comprises a plurality of curved segments la that contain a plurality of grooves 1c, 1f and a plurality of latches 1b. The barrel drum body 1 is held together by a plurality of metal straps 3d,3e that can be tightened and loosened. Each metal strap 3d,3e contains a metal strap body 3a, a latch 3b and a hook 3c where the latch 3b latches onto. The top metal strap 3d fits into the top groove 1f and the bottom metal strap 3e fits into the bottom groove 1c so that said metal straps 3d, 3e cannot move from the desired position. The pandero body 2 comprises a shell 2g with a top ring 2b comprising a plurality of top ring ears 2e and a plurality of tuning lugs 2d, as well as a bottom ring 2c comprising a plurality of hooks 2a and a plurality of bottom ring ears 2f. Each top ring ear 2e has a tuning lug 2d attached that is then fed through a bottom ring ear 2f. A washer 2i and lug nut 2h are screwed on to the tuning lug 2d. The barrel drum body 1 contains latches 1b latched on to the hooks 2a on the pandero body 2 while the metal strap body 3a of each metal strap 3d,3e rests in each of the grooves 1c, 1f and each of the latches 3b are latched onto the hooks 3c and tightened to form the instrument.

FIG. 1 shows an exemplary embodiment of the invention, according to this application. That being a percussive instrument, comprising: a pandero body 2, comprising a plurality of hooks 2a, a bottom groove, a removable top ring 2b, a plurality of top ring ears 2e, a removable bottom ring 2c, a plurality of bottom ring ears 2f, a plurality of tuning lugs 2d attached to the top ring ear 2e and fed through the bottom ring ear 2f and threaded at the bottom, a plurality of lug nuts 2h and washers 2i that can be spun up and down and tightened on said tuning lug, and a plurality of hooks 2a attached to the bottom ring 2c; a top metal strap 3d and a bottom metal strap 3e, each comprising a horizontal latch 3b; and a plurality of curved segments 1a, each curved segment 1a comprising a top groove 1f, a bottom groove 1c, a vertical latch 1b located in an upper extremity of each of the curved segments 1a, a first side comprising plugging holes and a second side comprising dowels; wherein the plurality of curved segments 1a forms a cylindrical barrel drum body 1 by successively attaching the dowel side of one segment to the corresponding plugging holes side of another segment; wherein each vertical latch 1b of the plurality of curved segments attaches to a corresponding hook 2a in the pandero body 2; and wherein the horizontal latch 3b of the top metal strap 3d attaches the top metal strap 3d to the top groove 1f and the horizontal latch 3b of the bottom metal strap 3e attaches the bottom metal strap 3e to the bottom groove 1c to hold the barrel drum body 1 in place.

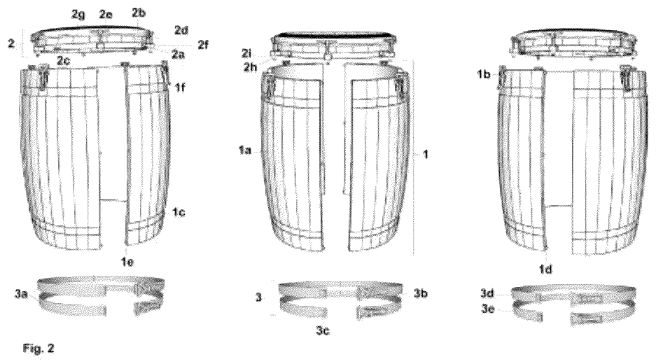

FIG. 2 shows multiple expanded views from different angles. The latches 3b attached to the metal strap bodies 3a on the metal straps 3d,3e are unlatched from the hooks 3c. The plurality of segments 1a of the barrel drum body 1 are separated. Each of the segments 1a comprises a plurality of dowels Id attached to one of the sides of each of the segments 1a and a plurality of plugging holes 1e on the other side of each of the segments 1a. The latches 1b of the barrel drum body 1 are unlatched from the hooks 2a attached to the bottom ring 2c of the pandero body 2. The pandero body 2 and the barrel drum body 1 are separated.

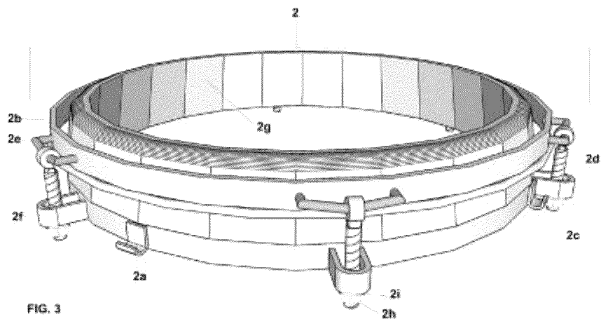

FIG. 3 shows an exemplary embodiment of the padero body 2 comprising a shell 2g with a top ring 2b comprising a plurality of top ring ears 2e and a plurality of tuning lugs 2d, as well as a bottom ring 2c comprising a plurality of hooks 2a and a plurality of bottom ring ears 2f. Each top ring ear 2e has a tuning lug 2d attached that is then fed through a bottom ring ear 2f. A washer 2i and lug nut 2h are screwed on to the tuning lug 2d.

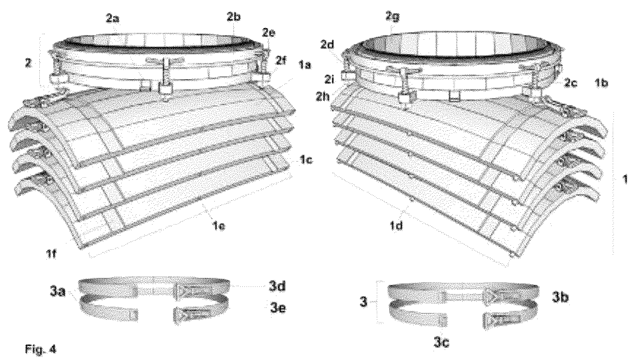

FIG. 4 shows multiple views of an exemplary embodiment of the disassembled barrel drum body 1 where a plurality of segments 1a are stacked on top of each other. The hooks 2a of the pandero body 2 are free from the latches 1b of the barrel drum body 1 and said pandero body 2 is stacked on top of the segments 1a and ready for travel. The dowels 1d are free from the plugging holes 1e. The plurality of grooves 1c, 1f that hold the metal straps 3d,3e in place are parallel to each other. Said metal strap 3d,3e latches 3b and hooks 3c, which are attached to the metal strap body 3a, are unlatched from one another.

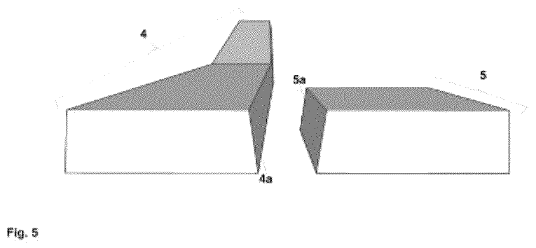

FIG. 5 shows an exemplary embodiment of the stave 4 used for the barrel drum body or barrel drum body segments after achieving the bend and the stave 5 used for the pandero body, both before gluing them. Each of the staves has a bevel 4a,5a along each of the sides at the length, the bevel being an angle at which the wood is cut.

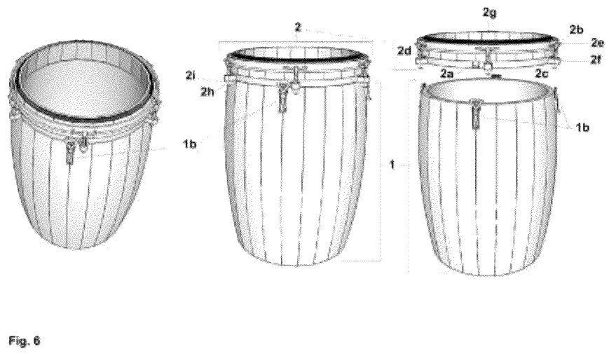

FIG. 6 shows an exemplary embodiment of the invention where all the staves are glued together, without the ability to separate the barrel drum body 1 into segments 1a and stack them for better traveling. The pandero body 2 is attached to the barrel drum body 1 via the plurality of latches 1b attached to the barrel drum body 1 that latch onto the hooks 2a on the pandero body 2.

What is claimed is:

1. A percussive instrument, comprising:
a. a pandero body, comprising a plurality of hooks, a bottom groove, a removable top ring, a plurality of top ring ears, a removable bottom ring, a plurality of bottom ring ears, a plurality of tuning logs attached to the top ring ear and fed through the bottom ring ear and threaded at the bottom, a plurality of nuts and washers that can be spun up and down and tightened on said tuning lugs, and a plurality of hooks attached to the bottom ring;
b. a top metal strap and a bottom metal strap, each comprising a horizontal latch and horizontal hook; and
c. a plurality of curved segments, each curved segment comprising a top groove, a bottom groove, a vertical latch located in an upper extremity of the curved segment, a first side comprising plugging holes and a second side comprising dowels;
i. wherein the plurality of curved segments forms a cylindrical barrel drum body by successively attaching the dowel side of one segment to the corresponding plugging holes side of another segment;
ii. wherein each vertical latch of the plurality of curved segments attaches to a corresponding hook in the pandero body; and
iii. wherein the horizontal latch of the top metal strap attaches the top metal strap to the top groove by latching on to the horizontal hook of the top metal strap and the horizontal latch of the bottom metal strap attaches the bottom metal strap to the bottom groove by latching on to the horizontal hook of the bottom metal strap to hold the barrel drum body in place.

2. The percussive instrument of claim 1, wherein:
a. each curved segment comprises a plurality of wooden staves;
b. each wooden stave has a minimum width of 1 inch, a minimum thickness of one (1) inch and a minimum length of 15 inches;
c. each wooden stave comprises a bevel, wherein the bevel is a minimum angle of seventy-two degrees;
d. a plurality of wooden staves is arranged to fit flush into the bevel of each wooden stave forming a plurality of segments with each segment having two exposed bevels;
e. a plurality of dowels are attached to one of the bevels of each segment;
f. a plurality of plugging holes to receive the dowels are drilled on the bevel of each segment opposite the dowels;
g. the top groove is carved into the outer top part of the segments; and
h. the bottom groove is carved onto the outer bottom part of the segments.

3. The percussive instrument of claim 1, wherein:
a. the pandero body is made up of a plurality of wooden staves;
b. each wooden stave has a minimum width of 1 inch, a minimum thickness of ¼ inch and a minimum length of 1.5 inches; and
c. each wooden stave comprises a bevel, wherein the bevel is a minimum angle of seventy-two degrees;
d. each stave is arranged to fit flush and attached into each other at each bevel such that it forms the circular shape of the pandero body;
e. a groove is carved on the outer bottom part of the pandero body.

4. The percussive instrument of claim 1, wherein each curved segment comprises a concave segment made of plastic, carbon fiber, fiberglass, or any other moldable material.

5. The percussive instrument of claim 1 wherein the pandero body is made out of plastic, carbon fiber, fiberglass, or any other moldable material.

6. A percussive instrument, comprising:
a. a pandero body, comprising a plurality of hooks, a bottom groove, a removable top ring, a plurality of top ring ears, a removable bottom ring, a plurality of bottom ring ears, a plurality of tuning lugs attached to the top ring ear and fed through the bottom ring ear and threaded at the bottom, a plurality of nuts and washers that can be spun up and down and tightened on said tuning lugs, and a plurality of hooks attached to the bottom ring; and
b. a barrel drum body comprising a plurality of vertical latches located in an upper extremity of the barrel drum body, wherein each vertical latch of the plurality of vertical latches attaches to a corresponding hook in the pandero body.

7. The percussive instrument of claim 6, wherein:
a. the barrel drum body comprises a plurality of wooden staves;
b. each wooden stave has a minimum width of 1 inch, a minimum thickness of 1 inch and a minimum length of 15 inches;
c. each wooden stave comprises a bevel, wherein the bevel is a minimum angle of seventy-two degrees;
d. the plurality of wooden staves are arranged to fit flush and attached into each other at each bevel such that it forms the cylindrical barrel drum body.

8. The percussive instrument of claim 6, wherein:
a. the pandero body is made up of a plurality of wooden staves;
b. each wooden stave has a minimum width of 1 inch, a minimum thickness of ¼ inch and a minimum length of 1.5 inches; and
c. each wooden stave comprises a bevel, wherein the bevel is a minimum angle of seventy-two degrees;
d. each stave is arranged to fit flush and attached into each other at each bevel such that it forms the circular shape of the pandero body;
e. a groove is carved on the outer bottom part of the pandero body.

9. The percussive instrument of claim 6, wherein the pandero body is made out of plastic, carbon fiber, fiberglass, or any other moldable material.

10. The percussive instrument of claim 6, wherein the barrel drum body is made out of plastic, carbon fiber, fiberglass, or any other moldable material.
